(19) United States
(12) Patent Application Publication
(10) Pub. No.: US 2014/0108377 A1
(43) Pub. Date: Apr. 17, 2014

(54) METHODS, SYSTEMS, AND COMPUTER READABLE MEDIA FOR LOCATING A LOST ANIMAL

(71) Applicant: Stephen M. West, Raleigh, NC (US)

(72) Inventor: Stephen M. West, Raleigh, NC (US)

(21) Appl. No.: 14/054,471

(22) Filed: Oct. 15, 2013

Related U.S. Application Data
(60) Provisional application No. 61/713,122, filed on Oct. 12, 2012.

(51) Int. Cl. G06F 17/30

(52) U.S. Cl. CPC G06F 17/3084
USPC 707/710

(57) ABSTRACT

Methods, systems, and computer readable media for locating a lost animal are disclosed. According to one aspect, a system includes a pet verification website host server that is configured to receive an uploaded video media file associated with an animal from a registered user, index the video media file in accordance to one or more animal feature criteria, receive a search query that includes the one or more animal feature criteria one or more animal feature criteria from a guest user, and provide access to one or more video media files associated with the search query to the guest user.

### PRIORITY CLAIM

This application claims the benefit of U.S. Provisional Patent Application No. 61/713,122, filed on Oct. 12, 2012, the disclosure of which is incorporated herein by reference in its entirety.

### TECHNICAL FIELD

The subject matter described herein relates to Internet based websites for locating lost pets and animals. More particularly, the subject matter described herein relates methods, systems and computer readable media for locating a lost animal.

### BACKGROUND

The implantation of embedded identification tags and transponders has recently been a controversial topic due to the notion that these devices can cause medical issues in animals or pets. For example, there have been instances of cancer in pets that have been subjected to embedded identification tags. Notably, cancer has been located proximate to the implanted tag and has been linked to the deaths of many pets. Other problems associated with embedded identification tags include adverse tissue reaction, movement of the implanted transponder, failure of the implanted transponder, failure of the electronic scanner, and the like.

Accordingly, in light of these difficulties, there is need for methods, systems and computer readable media for locating a lost animal.

### SUMMARY

According to one aspect, the subject matter described herein includes a system for locating a lost animal. In one embodiment, the system includes a pet verification website host server that is configured to receive an uploaded video media file associated with an animal from a registered user, index the video media file in accordance to one or more animal feature criteria, receive a search query that includes the one or more animal feature criteria from a guest user, and provide access to one or more video media files associated with the search query to the guest user.

The subject matter described herein may be implemented in hardware, software, firmware, or any combination thereof. As such, the terms “function” or “module” as used herein refer to hardware, which may also include software and/or firmware components, for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is flow chart illustrating an exemplary process for utilizing a website to locate a lost animal according to an embodiment of the subject matter described herein;

FIG. 2 is a display screen shot illustrating an exemplary home web page according to an embodiment of the subject matter described herein;

FIG. 3 is a display screen shot illustrating an exemplary owner profile according to an embodiment of the subject matter described herein;

FIG. 4 is a display screen shot illustrating an exemplary pet profile according to an embodiment of the subject matter described herein;

FIG. 5 is a display screen shot illustrating an exemplary lost pet list interface according to an embodiment of the subject matter described herein;

FIG. 6 is flow chart illustrating an exemplary process for providing access to video media files associated with a lost animal according to an embodiment of the subject matter described herein; and

FIG. 7 is a block diagram of an exemplary lost animal verification system according to an embodiment of the subject matter described herein.

### DETAILED DESCRIPTION

The present subject matter introduces methods, systems and computer readable media for locating a lost animal. One embodiment describes the identification of an animal using video capture and comparison techniques to positively identify an animal. Although the disclosure below describes the identification of pets, the disclosed subject matter may be applied to the positive identification of any animal (e.g., a trained animal, a zoo animal, a farm animal, etc.) using video capture and the disclosed techniques without departing from the scope of the present subject matter. The embodiment may also include processes for a pet verification website (e.g., Pet Video Verify website) to receive and/or capture an identification video (e.g., a video that displays and/or narrates a thorough description of a pet's appearance, mannerisms, characteristics, etc.). In some embodiments, the identification video may include a video capture file, a video media file, or the like. The pet verification website may also be configured to store the identification video and relevant information pertaining to the animal or pet. The website may also display information and identification videos associated with lost pets that are searchable by registered users and guest users.

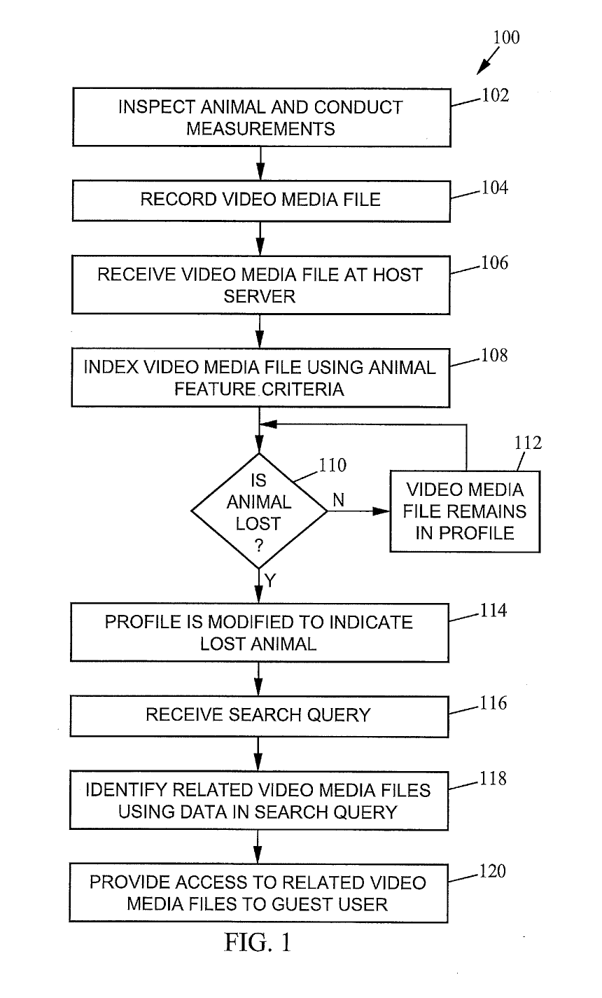

FIG. 1 depicts a flowchart of an exemplary method for identifying a lost animal. Although the description related to FIG. 1 details a method for identifying a lost pet, the method may be utilized with respect to other types of animals (e.g., zoo animals) without departing from the scope of the disclosed subject matter. In one embodiment, the method for identifying a lost animal may be conducted using a website that is supported by one or more host servers residing in a computer network, such as the Internet. Prior to creating a video media file related to a lost animal, a user and/or pet owner may perform a number of tasks aimed toward gathering information and identifying feature criteria related to an animal or pet. For example, in some embodiments, a pet owner (i.e., a user) may log onto a pet verification website (e.g., a Pet Video Verify website) and view a sample pet identification video. After viewing the sample pet identification video, the user is able to determine suggested requirements associated with what an uploaded pet identification video should entail. In some embodiments, these steps are optional.

In step 102, the pet owner takes the measurements of the pet. In one embodiment, the pet owner may note any items the pet owner wants to include in the identification video. The pet owner may also rehearse the video. Prior to the step, the pet owner may inspect (e.g., look over) the animal pet to identify animal feature criteria and conduct measurements. As used herein, animal feature criteria include characteristics, mannerisms, and/or physical features associated with an animal pet and may be included in an animal pet identification video.

In some embodiments, animal feature criteria includes physical features, such as the pet's body, the pet's body parts, markings on the pet's body and any other aspect which the owner may narrate and/or present in the identification video. Notably, the identification video may include the measurements associated with the pet's body, the pet's body parts, and markings on the pet's body. For example, the pet owner may measure the markings from a reference point (e.g., the pet's head) that can be shown in the identification video. Additional pet features that may be identified in the identification video may include the interior of the pet's mouth and any associated markings in the pet's mouth (e.g., maw, beak, etc.). More specifically, physical features including markings on the pet's teeth, the positioning of the pet's teeth, an indication of missing teeth, markings on the pet's tongue, a measurement of the pet's tongue, and the position of the tongue can be displayed and captured in the identification video.

Additional physical features associated with a pet's head, such as markings on pet's nose, a measurement of the pet's nose, how the nose moves, markings on the pet's eyes, measurements of eyes, and how the eyes move, markings on the pet's ears, a measurement of the pet's ears, and how the pet's ears move can be included on the identification video. Additional physical features associated with a pet's body, such as markings on the pet's legs, a measurement of the pet's legs, how the legs move, markings on the pet's feet (or paws), a measurement of the pet's feet, and how the pet's feet move can be included in the identification video. Additional physical features include markings on the pet's nails or claws, a measurement of the pet's nails or claws, markings on the pet's tail, a measurement of the pet's tail, and how the pet's tail moves can be included on the identification video. In addition, the type of hair (e.g., color, length, texture, straight, curly, short-haired, long-haired, etc.) of hair or fur the pet has can also be displayed and captured in the identification video.

In addition to physical features, characteristics and mannerisms of the pet may also be included in the identification video. For example, the unique manner in which a pet moves (e.g., walk, run, swim, fly, gait, etc.), the sounds the pet makes (e.g., bark, meow, caw, sing, moo, etc.), and how the mouth (or beak) moves in making the sound(s) can be captured and displayed in the identification video. Additional characteristics and mannerisms include the way the pet responds to a sound (e.g., an audible command, whistle, being called by its name, or any other noise made by a human or anything else that generates a sound). Other characteristics and mannerisms that may be included in the identification video include the way the pet sits, the way the pet lies down, the way the pet sleeps, the way the pet jumps, the way the pet eats (and what food pet likes), and the way the pet drinks can be included on the identification video. In addition, special tricks that the pet performs and the pet's medical conditions may be included in the identification video.

Returning to FIG. 1, in step 104, the pet owner uses a video recording device to record an identification video of the animal or pet. In one embodiment, the video recording device may include a video camcorder, smart phone video camera, a digital camera equipped with video recording function, or any other device that records or captures videos. The pet owner may narrate the video while he indicates/points (e.g., identified in step 102) to the animal feature criteria, such as special markings, the measurement of the markings (e.g., where the markings are measured), describing/narrating the distance/length (e.g., as measured in inches, centimeters, or any other length measurement) from two indicated points or anything specific or unique that the pet owner has identified on the pet body that can positively distinguish the pet from other similar animals. For example, this can include markings on the pet's body, measuring the markings on the pet's body, and measuring aspects of the pet's body itself. In another example, the pet owner may indicate the distance between two points on the pet by utilizing at least one reference point (e.g., the pet head) in the video. Notably, all of the physical features and characteristics disclosed above in the description of step 102 may be recorded and narrated in the identification video.

In step 106, the pet owner provides the identification video to a pet verification website (e.g., the Pet Video Verify website and/or host server). In one embodiment, the pet owner transfers an electronic video file from the video recording device to the pet verification website, either directly or via a personal computer or like device. For example, the pet owner may save the video capture file on the personal computer from the video recording device and subsequently upload the stored video capture file to the pet verification website (e.g., via the Internet).

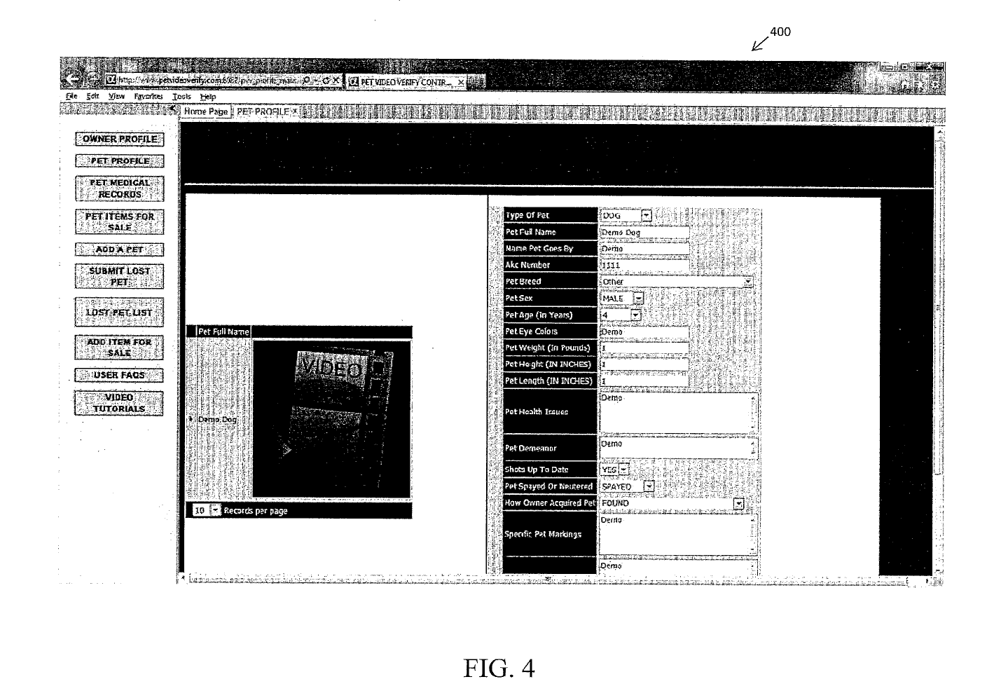

In step 108, a website computer system (e.g., Pet Video Verify website computer system) stores the pet information and identification video that the user (e.g., the pet owner) can view in his profile hosted by the website host server. The pet information in the profile can include pet type, pet name, pet full name, an American Kennel Club (AKC) number, breed, sex, age, eye color, weight, height, length, health issues, demeanor, medical shots, spayed or neutered status, how owner acquired pet, specific markings and measurements of said markings, special tricks, the actual identification video, and other relevant information. An exemplary pet profile as displayed on a website is depicted in FIG. 4 (as described below). In one embodiment, the present subject matter indexes the video media file in accordance to one or more animal feature criteria. For example, the website computer system or host server may allow a user to index and/or associate the pet information in the pet profile in a manner that allows the pet profile to be located by a subsequent query (e.g., utilizing searchable terms, checkboxes, pull-down menus, etc.). In one embodiment, the video file (e.g., video media file) may also be contained in an inactive/unsearchable storage until receiving an activation indication from the registered user. For example, the pet profile information and other information in a lost pet list cannot be used or accessed until such time the pet is designated and/or marked as lost and can be searched on this information. As used herein, a lost pet list includes i) a list of animals or pets that have been designated as lost or missing and ii) is maintained and managed by the pet verification website.

In step 110, the registered user determines if a pet is lost. If the pet has been lost, then method 100 continues to step 114. Otherwise, method 100 continues to step 112.

In step 112, the registered user determines the pet is not lost and designates and/or marks the pet as not lost in a pet verification website (e.g., Pet Video Verify website computer system). In one embodiment, by using the website user interface (UI) to indicate that the pet is not lost, the pet then is not included in the lost pet list but remains in the registered user's profile. Method 100 then loops back to step 110 and remains unchanged until the pet becomes missing or lost.

In step 114, the registered user modifies the user or owner profile to indicate that the pet is lost or missing. In some embodiments, if a pet belonging to a registered user is lost or becomes lost, the registered user may access his registered account on the pet verification website (e.g., Pet Video Verify website computer system) and use the UE to indicate that the pet is lost. The designation of the pet as lost may be done at any time during or after the user has registered an account. The designation and/or indication of the pet as lost serves as a trigger to include the pet information in the lost pet list (i.e., enables the pet profile to be accessed to other users that utilize a lost pet found query/search on the pet verification website). The information displayed in the lost pet list can include the identification video, type of pet, date last seen, last seen city, last seen state, last seen zip code, pet full name, name pet goes by, AKC number, breed, pet sex, age, eye color, weight, height, length, health issues, demeanor, medical shots, spayed or neutered status, how owner acquired pet, specific markings and measurements of said markings, special tricks, what pet means to owner, pet owner email, pet owner full name, pet owner city, pet owner state, pet owner country, veterinarian name, veterinarian address, veterinarian city, veterinarian state, veterinarian zip code, veterinarian telephone, veterinarian email, an offered reward, and other information.

In step 116, guest users and registered users can query and/or search the lost pet list on the pet verification website (e.g., Pet Video Verify website computer system). In some embodiments, the disclosed subject matter includes receiving a search query that includes the one or more animal feature criteria that is provided from a guest user at some time after the pet has been indicated to be lost. For example, information the users can search on the lost pet list page can include an identification video, type of pet, date last seen, last seen city, last seen state, last seen zip code, pet full name, name pet goes by, AKC number, breed, pet sex, age, eye color, weight, height, length, health issues, demeanor, medical shots, spayed or neutered, how owner acquired pet, specific markings and measurements of said markings, special tricks, what pet means to owner, pet owner email, pet owner full name, pet owner city, pet owner state, pet owner country, veterinarian name, veterinarian address, veterinarian city, veterinarian state, veterinarian zip code, veterinarian telephone, veterinarian email, a offered reward, and other information.

In step 118, related video media files are identified using data in the search query. In one embodiment, the animal feature criteria associated with the search query is compared with the animal feature criteria stored in the host server. If the search query includes terms that are closely related to the animal feature criteria associated with one or more identification videos, then identification videos associated with the matching or correlated pet information are identified. For example, the user may utilize the website UI (e.g., via text query, pull-down menus, check boxes, etc.) to submit a search query that includes one or more of the aforementioned pet related data. The website host server may then attempt to match the pet related information provided in the search query with other pet information that has been previously indexed and stored by the host server (e.g., see step 108). If the website host server identifies a match or a correlation between the search query information and the indexed pet related information, then the host server may identify the appropriate identification video(s) associated with the matching or correlated indexed pet related information.

In step 120, access to the related video media fields is provided to a guest user. In some embodiments, after the search query is conducted, the pet verification website may respond by presenting and providing access to one or more video media files associated with the search query to the guest user. For example, the identification videos identified in step 118 are made accessible to the querying guest user.

An example of the pet video identification provisioning (e.g., uploading) process may initially involve the user connecting the video recording device to a computer (e.g., a personal computer (PC)). Once the device and computer are connected, the user may then copy or transfer the identification video from the video recording device to the computer. The user can then access and/or login to the pet verification website (e.g., Pet Video Verify computer website). This process may similarly be achieved if the user recorded the identification video using a smart phone or any other video recording device that performs video recording functions. The user may then select and/or click (e.g., via a user interface (UI) element or button) on the pet profile page, and subsequently click on the registered pet UI element, thereby accessing (e.g., bringing up) that pet's information. For example, the user may then select and/or click on the pet profile page, then select and/or click on the specific pet, thereby accessing/bringing up that pet's profile information. The user may then click the “upload video identification” button on the website. The user may then locate the identification video stored locally on their computer, smartphone, or any device (e.g., Google glass) that performs the necessary functions and subsequently upload the video capture file to the website host server. The video capture file is then stored on the pet verification website host server (e.g., Pet Video Verify computer website system or host server) in an mp4 format or any format that is compatible with the pet verification website. In one embodiment, the pet verification website host server can convert an incompatible video capture file into a compatible format. The reference to a pet's video identification is stored in a database (e.g., a database local or external to the host server) and is linked to that pet's information. The user can view the identification video by clicking the video icon (e.g., a UI element) in the pet profile or owner profile. If the user marks or indicates the pet as lost, then the user or guest user can click the video identification icon (e.g., a UI element) to view the identification video from the lost pet list.

In some embodiments, the registered user can input information related to the owner (e.g., registered user) and pet using the website user interface. The registered user may login to a pet verification website (e.g., Pet Video Verify computer website). The user may then click on the owner profile button (e.g., a UI element) to retrieve the owner profile page. The registered user can update information on the owner by typing information into text boxes, using pull-down menus, checking checkboxes, and the like. This information includes owner's full name, owner email, owner address, owner city, owner state, owner zip code, owner country, owner telephone number, owner cellphone number, owner fax number, veterinarian name, veterinarian address, veterinarian city, veterinarian state, veterinarian zip code, veterinarian telephone number, veterinarian fax number, veterinarian email address, and other information. Once finished updating information, the user may click “submit” (e.g., a UI element) to save the information. This information is saved in a database and is linked to the user's profile. The registered user then can click on the pet profile button (e.g., a UI element) to retrieve the pet profile page. The registered user may then update information on the pet by typing information into text boxes. This information includes type of pet, pet full name, name pet goes by, AKC number, pet breed, pet sex, pet age, pet eye color, pet weight, pet height, pet length, pet health issues, pet demeanor, medical shots, spayed or neutered, how owner acquired pet, specific pet markings, special tricks, and other information. Once finished updating information, the user can click submit to save the information. This information is saved in a database and is linked to the pet's profile.

In some embodiments, the registered user or guest user can utilize the website to search the lost pet list based on criteria the user enters into the search text boxes, using pull-down menus, checkboxes, or the like. For example, after the user enters criteria into text boxes, the user may submit the search by clicking/interfacing with the search button. The search criteria may include pet owner city, owner state, owner country, type of pet, pet breed, sex, age, eye color, weight, height, length, date pet last seen, last seen city, last seen state, last seen zip code, and other information, such as pet characteristics and mannerisms. The user can sort information by the fields above and can limit the results to a certain number of returns per page.

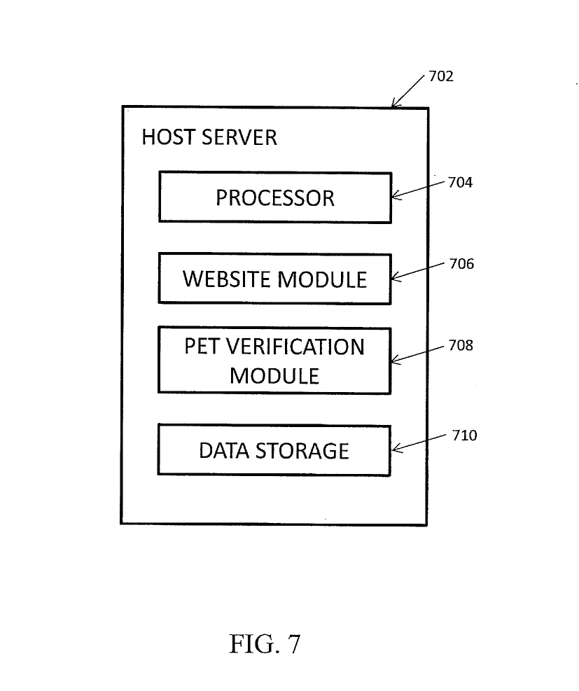

In one embodiment, the process depicted by the flowchart in FIG. 1 may be performed at least in part by one or more computers equipped with hardware based processing units configured to execute software or firmware (see also FIG. 7). The one or more computers may be any kind of computing device, such as a general purpose computer or some specific purpose computer, such as a workstation or dedicated server. For example, the computer may include an Intel (e.g., Pentium or Core 2 Duo) processor based computer or an AMD processor based computer configured to run a Windows or Linux operating system. Alternatively, the computer may be an Apple computer (e.g., a Macintosh computer). The computer or computer device may also include a laptop computer or a handheld computer, such as a personal digital assistant (PDA), cellular smartphone, or tablet computer. The website (and included webpages) and programs may be written in C, Java, Xbasic, HTML, XML, and/or any other programming language. The website and programs may reside on a non-transitory storage medium (e.g., magnetic or optical) such as a computer hard drive, a removable disk or media such as a memory stick or SD media, wired or wireless network based or Bluetooth based Network Attached Storage (NAS), or other removable medium in the host server. The website and programs may also be executed by a local machine, which allows the local machine to carry out the operations described herein. In one embodiment, a local machine may include a personal computer or any computer device that the user utilizes.

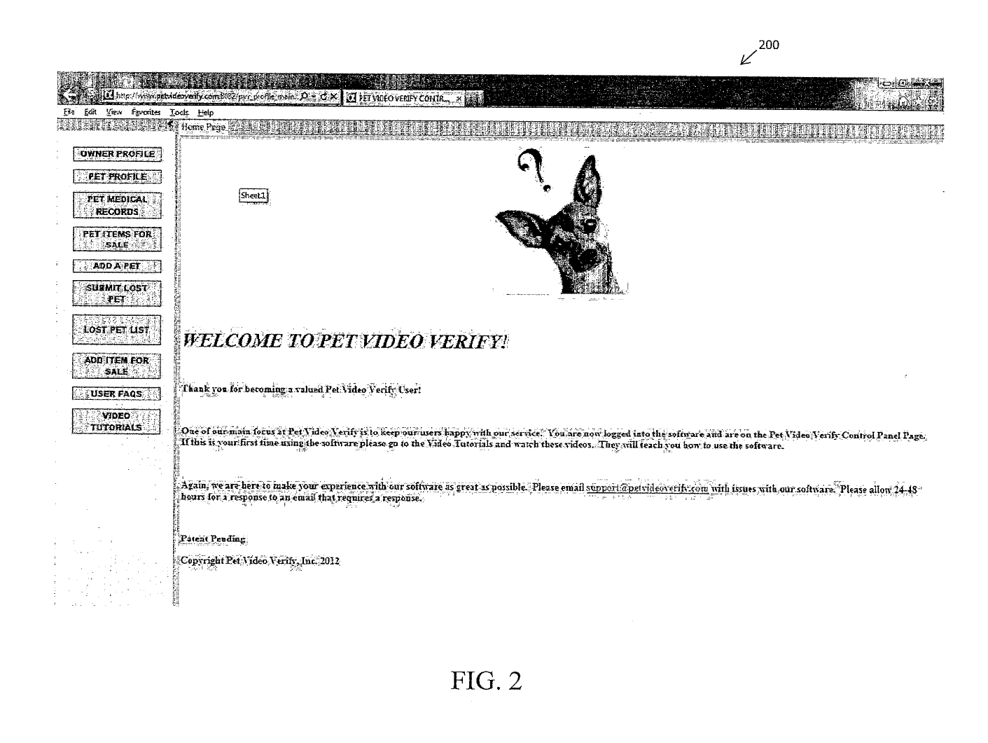

FIG. 2 depicts a display screen shot 200 illustrating an exemplary home web page according to an embodiment of the subject matter described herein. In one embodiment, the home web page may function as a welcome page to registered and unregistered users accessing the website. The home page may include a welcome message and a plurality of user interface (UI) elements, such as UI interface buttons (e.g., see left side of FIG. 2) that may be utilized by a user. For example, any of the plurality of interface buttons may be selected and/or clicked by the user in order to access additional services and features, such as adding/editing an owner profile, adding/editing a pet profile, providing pet medical records, submitting/designating a lost pet, accessing a lost pet list, and the like. In one embodiment, the home web page depicted in display screen shot 200 may be implemented by executing a website software program or module (e.g., see module 706 in FIG. 7).

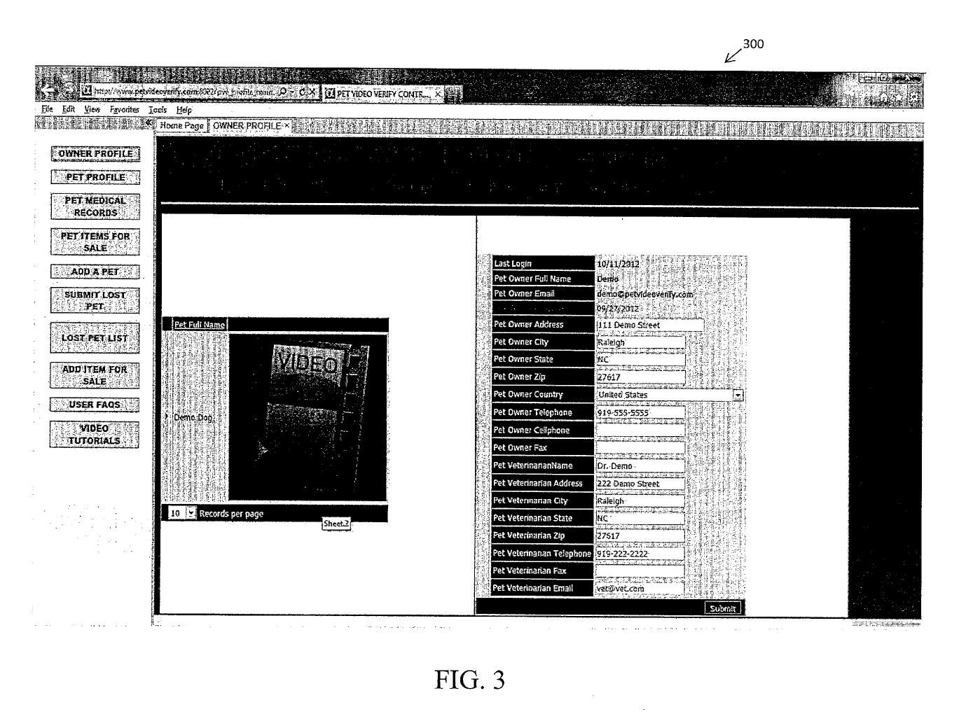

FIG. 3 depicts a display screen capture 300 illustrating an exemplary owner profile according to an embodiment of the subject matter described herein. For example, the owner profile web page displayed in FIG. 3 includes a video section and an owner profile data section. In one embodiment, the video section includes a portion of the web page designated to contain a video file that may be readily selected for viewing by a user. Similarly, the profile data section may include a plurality of data fields that may contain and/or receive data that is specific to a pet owner. Exemplary data fields located in the pet owner profile section include the pet owner name, pet owner contact information, pet owner address, pet veterinarian name, pet veterinarian contact information, pet veterinarian address, and the like. In one embodiment, the owner profile depicted in display screen shot 300 may be implemented by executing a website software program or module (e.g., see module 706 in FIG. 7).

FIG. 4 depicts a display screen capture 400 illustrating an exemplary pet profile according to an embodiment of the subject matter described herein. For example, the pet profile web page displayed in FIG. 4 includes a video section and a pet profile data section. In one embodiment, the video section includes a portion of the web page designated to contain a video file that may be readily selected for viewing by a user. Upon selecting the video file, a video depicting and describing features/characteristics/mannerisms of an associated pet will be displayed. Similarly, the pet profile data section may include a plurality of data fields that may contain and/or receive data that is specific to an animal pet. Exemplary data fields located in the pet profile section include pet name, pet measurements, pet characteristics, pet medical information, and other pet related information. In one embodiment, the pet profile depicted in display screen shot 400 may be implemented by executing a website software program or module (e.g., see module 706 in FIG. 7).

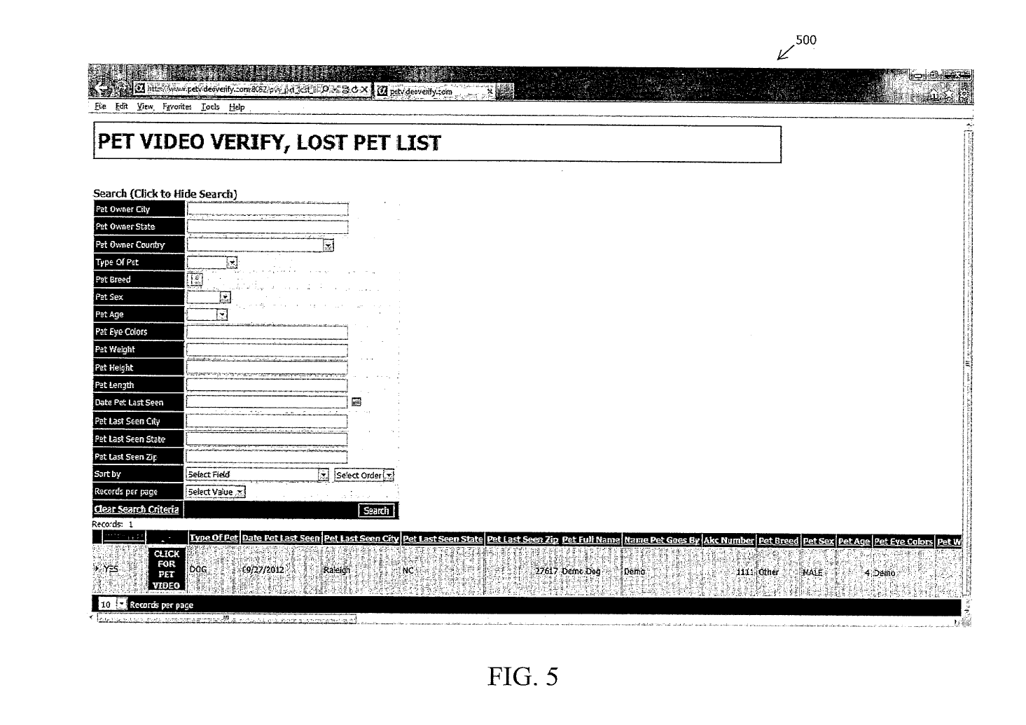

FIG. 5 is a display screen capture 500 that illustrates an exemplary lost pet list interface according to an embodiment of the subject matter described herein. For example, the lost pet list web page displayed in FIG. 5 may include a plurality of data fields that are utilized by a user to search for a lost pet. Namely, a plurality of data fields used to search for a lost pet includes a pet owner location (e.g., city, state, and country) and a plurality of characteristics associated with a lost pet. FIG. 5 also displays an exemplary data results table that includes entries associated with lost pets that match the provided search criteria provided by the user. Each entry of the data results table may also include user interface (UI) elements, such as a button or link, to access its respective pet profile web page (not unlike the pet profile included in FIG. 4). In one embodiment, the lost pet list interface depicted in display screen shot 500 may be implemented by executing a website software program or module (e.g., see module 706 in FIG. 7).

In some embodiments, computer software can be used to make electronic measurements of everything mentioned above that can be compared to videos submitted by users to make a positive identification of a pet. For example, a computer software program may be configured to focus on the pet in the video and conduct electronic measurements of the pet. The computer software program then utilize those measurements and compare them to a video that a user films of a lost pet and filters based on the criteria. The result may be one pet or several pets that the user can view to make a positive identification. In one embodiment, an executed software algorithm or module (e.g., module 708 in FIG. 7) may be executed to perform the aforementioned tasks.

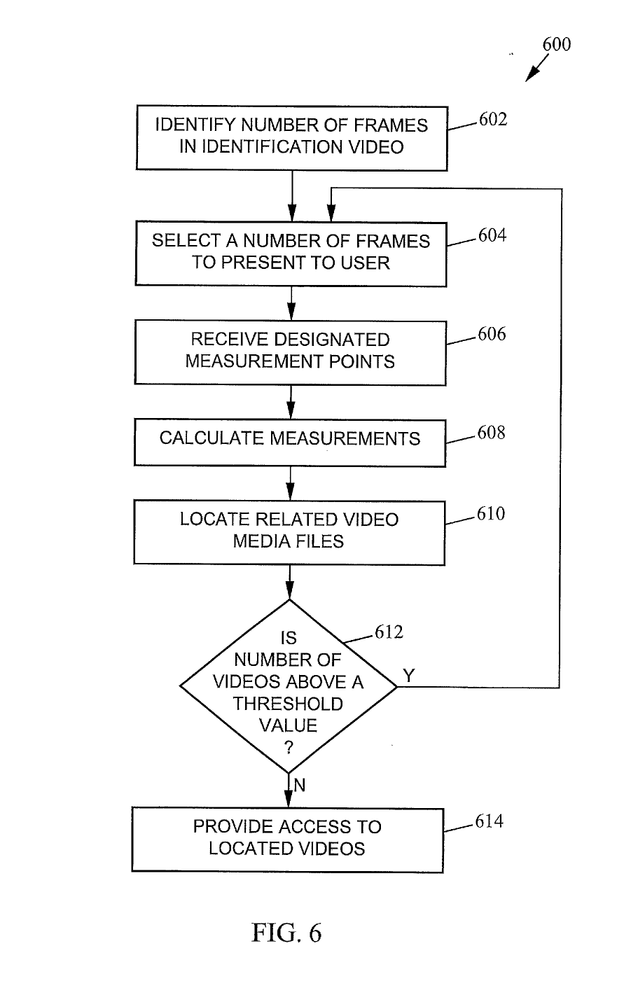

FIG. 6 is flow chart illustrating an exemplary method 600 for providing access to video media files associated with a lost animal according to an embodiment of the subject matter described herein. After the registered user submits a pet profile identification video (i.e. potential lost pet video), the user may be provided with options by an algorithm regarding how many pet markings, which pet body parts, and the like that the user wants to have electronically measured. In one embodiment, an executed software algorithm or module (e.g., module 708 in FIG. 7) may be executed to perform method. 600.

In step 602, the number of frames in an identification video is identified. In some embodiments, an algorithm determines the number of frames in the identification video. For example, the video recording may be processed by the algorithm which segments the video recording into individual frames. In an alternate embodiment, the algorithm is also configured to store the determined number of frames in a database storage associated with a host server.

In step 604, a number of frames are selected to present to a user. In some embodiments, the algorithm may select a random number of frames included in the identification video in order to present to the user. In some embodiments, the algorithm may also determine the specific quality of the identification video (e.g., standard definition, high definition, ultra definition, etc.) in order to determine the number of frames selected.

In step 606, designated measurement points are received. In some embodiments, a user may indicate measurement points (e.g., data points) in a digital frame provided by the algorithm. For example, the algorithm may then prompt the user to indicate a starting reference point and an ending reference point of each marking, body parts, and the like that the user or algorithm designated to be included. The algorithm may then select frames of the video file that the algorithm requests the user to designate additional reference points (e.g., more starting and ending reference points) based on the selections that the user and algorithm wanted to include.

In one exemplary embodiment, the user may designate the right ear of the animal as a first measurement point and the second ear as a second measurement point. The user may be prompted to provide a number of measurements in each of the selected digital frames. In some embodiments, the algorithm may provide an option to a user to scan through the individual frames of the identification video with the capability of zooming in on a frame to more accurately mark the areas where the electronic measurements will be taken.

Additional measurement points or data points include audible sound data and GPS data. For example, the application may be used to make a sound recording of either an animal making noise. (e.g., a dog's bark) or the words spoken to the animal to record certain data points. The application may require recording the animal sounds at a certain sound quality. The application may also record GPS location information on where the animal was lost and record these data points.

In step 608, measurements are calculated. In some embodiments the algorithm may process the various reference points and derive calculated measurements (e.g., measurement points). For example, the algorithm may determine the number of pixels that lie between two or more measurement points to calculate a measurement. In an alternate embodiment, the application may also store these unique measurement points into a database containing specific fields (e.g., fields associated with body part categories) to record data for each measurement point.

In step 610, related video media files are located. In some embodiments, a query is run via the algorithm to determine the number of matches between identification videos (i.e., lost pet videos) and found pet videos.

In step 612, a determination is made by the algorithm as to whether the number of videos is above a threshold value. If the number of located video media files is above a threshold value, then method 600 loops back to step 604. In such a case, the algorithm may prompt the user to select additional markings, pet body parts, and the like in the pet profile identification video (i.e., potential lost pet video) to increase the relevancy and accuracy of the related video media files. For example, the algorithm may prompt or require the user to mark additional points of the pet in certain frames of the identification video to get more measurement points. If the number of located video media files is not above a threshold value, then method 600 loops back to step 604

In step 614, access to the located videos is provided. In some embodiments, a user is provided (by the algorithm) with access to each of a listing of video files that have been identified as being related to the original identification video.

FIG. 7 depicts a block diagram of an exemplary lost animal (e.g., lost pet) verification system. In one embodiment, a lost pet verification system may include a single host server 702. In some embodiments, host server 702 may include any server, node, computer, or unit that is configured to identify a lost animal using the disclosed methods. Although FIG. 7 depicts host server 702 as a single network element, host server 702 may include a plurality of network elements, a plurality of network components, and/or a network itself (e.g., host servers with external databases) without departing from the scope of the present subject matter. In some embodiments, host server 702 may include a processor 704, a website module 706, a pet verification module (or animal verification module) 708, and a local data storage unit 710. In some embodiments, processor 704 may include a microprocessor, central processing unit (CPU), or any other like hardware based processor unit that is configured to execute and/or utilize website module 706 and pet verification module 708 (e.g., software or firmware based algorithms) to collectively host a website designed to receive, store, manage, and provide video media files used to identify a lost animal or pet. In some embodiments, website module 706 and pet verification module 708 may be stored in memory (not shown), such as random access memory (RAM), read only memory (ROM), optical read/write memory, cache memory, magnetic read/write memory, flash memory, or any other non-transitory storage media. In one embodiment, processor 704 and memory may be used to execute and manage the operation of website module 706 and/or pet verification module 708.

In some alternative embodiments, the application may run through each frame of the video file with the specific points marked collecting data into certain fields to indicate the manner in which the pet moves and characteristics that are unique to the pet. As more identification videos (i.e., potential lost pet videos) are uploaded to the system by newly created users, the application may require previous users to mark more starting reference point and ending reference point of their video identification (i.e., potential lost video) to increase accuracy of the pets unique mannerisms, markings, body parts, etc. Found pet video identification submitted by a registered or non-registered user also may go through the same process of establishing data points to be stored in a database as submitting a pet profile identification video (i.e., potential lost pet video). This may filter the list of found pet(s) to one or several lost pet videos. Contact information may be returned on the website or mobile application that contains information on the pet's owner, enabling to make contact to return the lost pet.

The video identification process may also be used to call other applications on the website or mobile application. For example, to display a pet's medical record, the application to display just that pet's medical record(s) may be called by using the same video identification process described above. This may help a veterinarian or personnel retrieve vital information when the pet's identity is unknown.

In some embodiments, a user may utilize a mobile application (e.g., a mobile device “app”) that is provisioned on a mobile smartphone and is configured to interact with the system and/or host server. For example, a user may first use a wireless mobile device (e.g., a smartphone, a tablet computer, etc.) to download the application for the appropriate device. In some embodiments, mobile devices include certain built-in components that the Pet Video Verify system may interact with or utilize. Exemplary built-in components include a video camera that a user can use to shoot (i.e., record) a pet identification video, a fingerprint scanner that can be used to scan an image of the paw (foot), nose, eye, or other parts of the animal, and an audio sound recorder that may be used to record an animal sound (e.g., bark, meow, moo, etc.) or the sound of a person talking to the animal that triggers a reaction from the pet. Once the application is loaded on the mobile device, the user may select an icon on the mobile device that represents the application in order to establish a connection to the Pet Video Verify system or host server. If the user is already registered with the system (e.g., a preregistered pet owner), the user may simply login to the application. After logging in, the application presents the user with an user interface that may include information, such as the owner's name, owner's address, owner's contact information, pet's name, pet's height, pet's length, pet's weight, pet's eye color(s), pet's body parts measurements, and other information that was previously provided (e.g., upon establishing a registration or account). The mobile application may also include the identification video taken of an animal. The mobile application may include the image of the digital print of the paw (foot), nose, eye, and other features associated with the animal. Utilizing the mobile application, a user may click on (i.e., access) the identification video and be presented with the choice to either view the identification video or to shoot another identification video. If the user decides to shoot another identification video, then the application may utilize the video camera on the mobile device to record the new identification video. The identification video may then be uploaded by the application to the Pet Video Verify system or host server. The mobile application may also provide the user to ability to designate and mark various attributes of the pet in the identification video and submit the identification video to the system for processing. The mobile application may allow the user to click on the digital frame image of the pet's paw (foot), nose, eye, and the like. The application may present the user with an option to change the digital frame images of the identification video by using the finger scanner, camera, or any other device/component on the mobile device. This information may then be submitted back to the Pet Video Verify system. The user may also use the application to select the sound of the pet or a person and listen to the sound through the speaker element(s)/device(s) on the mobile device. The user may have an option to change the sound associated with the pet or person using a microphone component in the mobile device to record the sound. This information may then be submitted back to the Pet Video Verify system.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for locating a lost animal, the method comprising:
receiving, at a website configured to provide identification information associated with one or more lost animals, an uploaded video media file associated with an animal from a registered user;
indexing the video media file in accordance to one or more animal feature criteria;
receiving a search query that includes the one or more animal feature criteria from a guest user; and
providing access to one or more video media files associated with the search query to the guest user.

2. The method of claim 1 further comprising:
inspecting the animal for the one or more animal feature criteria;
generating the video media file of the animal, wherein the video media file includes a narrated presentation of the one or more animal feature criteria associated with the animal; and
providing, to the website, the video media file for display.

3. The method of claim 2 wherein providing the video media file includes uploading the video media file to the website.

4. The method of claim 1 wherein receiving an uploaded video media file includes storing the uploaded video file on a host server associated with the website.

5. The method of claim 1 wherein the animal includes at least one of: a lost pet, a lost zoo animal, a lost trained animal, and a lost farm animal.

6. The method of claim 1 further comprising storing the video media file until receiving an activation indication from the registered user.

7. A system for locating a lost animal, the system comprising:
a pet verification website host server that is configured to:
receive an uploaded video media file associated with an animal from a registered user;
index the video media file in accordance to one or more animal feature criteria;
receive a search query that includes the one or more animal feature criteria from a guest user; and
provide access to one or more video media files associated with the search query to the guest user.

8. The system of claim 7 wherein the host server is further configured to store the uploaded video file.

9. The system of claim 7 wherein the animal includes at least one of: a lost pet, a lost zoo animal, a lost trained animal, and a lost farm animal.

10. The system of claim 7 wherein the host server is further configured to store the video media file until receiving an activation indication from the registered user.

11. A non-transitory computer readable medium having stored thereon executable instructions that when executed by the processor of a computer control the computer to perform steps comprising:
receiving, at a website configured to provide identification information associated with one or more lost animals, an uploaded video media file associated with an animal from a registered user;
indexing the video media file in accordance to one or more animal feature criteria;
receiving a search query that includes the one or more animal feature criteria from a guest user; and
providing access to one or more video media files associated with the search query to the guest user.

12. The computer readable medium of claim 11 further comprising:
inspecting the animal for the one or more animal feature criteria;
generating the video media file of the animal, wherein the video media file includes a narrated presentation of the one or more animal feature criteria associated with the animal; and
providing, to the website, the video media file for display.

13. The computer readable medium of claim 12 wherein providing the video media file includes uploading the video media file to the website.

14. The computer readable medium of claim 11 wherein receiving an uploaded video media file includes storing the uploaded video file on a host server associated with the website.

15. The computer readable medium of claim 11 wherein the animal includes at least one of: a lost pet, a lost zoo animal, a lost trained animal, and a lost farm animal.

16. The computer readable medium of claim 11 further comprising storing the video media file until receiving an activation indication from the registered user.
